(19) United States
(12) Patent Application Publication
(10) Pub. No.: US 2008/0280206 A1
(43) Pub. Date: Nov. 13, 2008

(54) PROCESS FOR REALIZING AN ELECTRODE BASED ON VANADIUM OXIDE AND BATTERY COMPRISING SUCH AN ELECTRODE

(75) Inventor: Sami Oukassi, Grenoble (FR)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: STMicroelectronics S.A., Montrouge (FR)

(21) Appl. No.: 12/118,036

(22) Filed: May 9, 2008

(30) Foreign Application Priority Data
May 11, 2007 (FR) 07 03397

(51) Int. Cl. H01M 4/48; H01M 4/08

(52) U.S. Cl. 429/231.5; 204/192.17

(57) ABSTRACT

A process for realizing a positive electrode of a lithium-ion battery utilizes deposition by cathode sputtering in several steps. Two successive deposition steps are separated by a cooling of the electrode during its realization, a first intermediate step of sputtering the target without introducing oxygen, and a second intermediate step of sputtering the target while introducing oxygen. The electrode obtained is of amorphous vanadium oxide and exhibits good capacity and reversibility.

### PRIORITY CLAIM

The present application is a translation of and claims priority from French Patent Application No. 07 03397 of the same title filed May 11, 2007, the disclosure of which is hereby incorporated by reference to the maximum extent allowable by law.

### BACKGROUND OF THE INVENTION

1. Technical Field of the Invention

The present invention relates to a process for realizing an electrode based on vanadium oxide as well as a battery comprising such an electrode.

2. Description of Related Art

It is known to realize a lithium-ion battery which comprises a positive electrode based on amorphous vanadium oxide, a negative electrode based on metallic lithium, and an electrolyte placed between the positive and negative electrodes. The electrolyte can be a portion of a material based on lithium and phosphorous oxynitride, commonly called LiPON. Such a battery can have a layered structure, in which the two electrodes, the electrolyte, and the electrical terminals in contact with the electrodes are each constituted of a thin film of corresponding material. This structure is particularly suitable for forming a battery of small dimensions, called a microbattery.

One application for such a microbattery is as a backup for data stored in a chip of an integrated circuit when the primary source of power for the chip is cut off. In this application, realizing the microbattery directly on the chip is possible, in order to avoid the cost of assembling the microbattery with the chip when they are each manufactured separately. But when the microbattery is manufactured on the chip in this manner, the manufacturing must not require heating the chip to a high temperature which could damage the chip.

Another possible fabrication method for thin film batteries consists of depositing the layers of materials constituting the various components of a battery onto a polymer film which serves as a support. It is advantageous if this film is flexible. A battery is then realized from a portion of the polymer film which is cut out, and which is then possibly used for edging each layer and for placing electrical connections. Such a manufacturing method is particularly economical, but also requires that the process of forming the thin layers of the various battery components does not cause significant heating of the polymer film so that there is no degradation of the film.

The discharge capacity of a battery is the amount of electrical charge the battery can supply to an electrical device. A discharge capacity is required which is high relative to the geometric dimensions of the battery, and which remains constant after many uses. In other words, the discharge capacity and its decrease over successive battery utilization cycles constitute important criteria for evaluating a battery.

Secondary evaluation criteria are, in particular, the reversibility of the battery and its internal electrical resistance. Reversibility means the variation in the battery capacity between a charge step and a consecutive discharge step. In other words, reversibility is the ability of the battery to supply, during a discharge, the amount of electricity previously provided to it during a charge.

It is known to use vanadium oxide, of the stoichiometric formula V₂O₅, as a positive electrode material for a lithium-ion battery. The sign of an electrode is conventionally indicated for a discharge step of the battery, meaning when the battery is serving as a source of electrical energy for an electrical device connected to it. Under these conditions, the positive electrode corresponds to the cathode of the battery. One of the main advantages of vanadium oxide over other known positive electrode materials is that it does not require any high temperature processing to be electrically functional. In other words, a portion of vanadium oxide can be directly used within a battery without prior heating. This property is particularly suitable for realizing microbatteries on chips of integrated circuits or on polymer films.

However, positive electrodes formed of thin layers of vanadium oxide do not perform as well as those made of alternative materials. In particular, a positive electrode of crystalline vanadium oxide has a low capacity and a surface roughness which gives significant internal resistance to the battery.

For these reasons, it is known to realize a positive electrode of a lithium-ion battery of amorphous vanadium oxide. The capacity of the battery is then initially superior, but it decreases during repeated uses of the battery because of structural modifications which occur in the amorphous material of the positive electrode, particularly when it possesses a low density.

In addition, the increase in temperature which occurs during the realization of the positive electrode of amorphous vanadium oxide is likely to trigger at least partial crystallization of the vanadium oxide. The electrical performance of a battery realized from such a positive electrode is then degraded.

There exists a need in the art for a process for realizing a positive electrode of vanadium oxide which is amorphous and which presents an improved electrical performance relative to what was previously obtained for this material.

### SUMMARY OF THE INVENTION

To this end, a new process is proposed for realizing an electrode based on vanadium oxide, adapted to reversibly absorb lithium ions delivered by a portion of electrolyte simultaneously with electrons delivered by an electrical terminal. This electrode is formed by cathode sputtering of a vanadium-based metal target by means of a plasma which contains argon and oxygen, and which is powered by a discharge of alternating current. The process realizes the electrode in at least three deposition steps, with two successive deposition steps being separated by: (A) a cooling of the electrode being realized to a temperature of less than 50° C., (B) a first intermediate step of sputtering the target without introducing oxygen into the plasma, for a first period which is greater than 2 minutes, and (C) a second intermediate step of sputtering the target in the presence of oxygen, for a second period which is longer than 2 minutes.

In addition, steps (B) and (C) are realized while the electrode is isolated from atoms originating from the target.

A deposition process uses cathode sputtering in a vacuum. Such a deposition process is well understood, and thus allows for producing a good yield of vanadium oxide electrodes using commercially available deposition tools.

The realization of the electrode in several deposition steps, which are separated in particular by steps (A) of cooling the electrode itself, avoids obtaining vanadium oxide material which is crystalline. This material is therefore at least partially amorphous, so that the electrode realized has a high capacity. This amorphous structure additionally presents a slight roughness on the surface of the electrode, which contributes to reducing the internal resistance of a lithium-ion battery incorporating this electrode.

Each deposition step is preferably stopped before the temperature of the electrode being manufactured reaches 150° C. Thus, the increase in the electrode temperature which may occur is insufficient to cause crystallization of the vanadium oxide material already deposited.

In addition, the variations in the temperature of the electrode during the manufacturing process are insufficient to degrade a substrate of the electrode, particularly when this substrate comprises a chip of an integrated circuit or a portion of polymer material. The process of the invention therefore allows realizing the vanadium oxide electrode on such a substrate during the cathode sputtering deposition steps.

It is possible for the duration of each deposition step to be less than 30 minutes, and preferably between 10 and 20 minutes, to further limit any heating of the electrode and substrate during the realization of the electrode.

The intermediate steps (B) and (C) restore a state to the surface of the vanadium target which is close to what existed at the start of the process. In this manner, alterations to the state of the target surface which arise during execution of the entire process are limited, such that the vanadium oxide material which constitutes the electrode is fairly homogenous throughout the entire thickness of the electrode. Thus, different portions of the obtained electrode contribute in the same manner to the capacity, which avoids the appearance of points of saturation, overload, or overheating in the electrode during its use within a complete battery.

The electrical discharge of current to the plasma can be adjusted during each deposition step so as to obtain a vanadium oxide deposition rate which is between 1 and 20 nm/min (nanometers per minute). This interval represents a particularly advantageous comprise between a deposition rate which is not too high in order to limit the heating of the electrode being created, and a total duration for the process which is not too long. Preferably the deposition rate of the vanadium oxide is between 5 and 10 nm/min.

The intermediate step (B), in which the target is sputtered with a neutral plasma, produces a stripping of the target surface. At the end of this step, the material uncovered at the surface of the target is at least partly of metal, with characteristics which are close to or identical to those of the material present in the bulk of the target.

The intermediate step (C), in which the target is sputtered with an oxidizing plasma, treats the target so as to regain deposition conditions which are analogous to those at the start of the previous deposition step. When such deposition conditions are again obtained, the electrode being realized is exposed once more to the plasma, such that the realization of the electrode is continued during a next deposition step.

The durations of the intermediate steps (B) and (C) are chosen such that the state of the surface of the target at the start of each deposition step gives deposition conditions which are substantially constant during the entire deposition step. In fact, no significant shift in certain deposition control parameters is reported. The vanadium oxide electrode is then correctly homogenous.

It is advantageous if the respective first and second durations of steps (B) and (C) are between 2 minutes and 30 minutes, to reduce the duration of the entire process. They preferably exceed 5 minutes so as to obtain sufficient regeneration of the target.

It is preferable if identical quantities of argon and oxygen are introduced into the plasma during the intermediate step (C) and during the following deposition step. In this manner, continuity is established between these two steps, which contributes to ensuring that all deposition steps are performed under identical and controlled conditions, in order to further guarantee the obtaining of a positive electrode which is homogenous throughout.

In one particular embodiment, the argon partial pressure is between 0.1 Pascal and 2 Pascal during steps (B) and (C), and the oxygen partial pressure is between 0.01 Pascal and 0.2 Pascal during step (C). These values result in effective intermediate steps, restoring the state of the target surface without requiring said intermediate steps to be too long.

The invention also proposes a lithium-ion battery which comprises a positive electrode formed of a thin layer based on amorphous vanadium oxide, a negative electrode, and an electrolyte which is placed between the positive and negative electrodes, with the battery having a discharge capacity which is greater than 45 microampere.hours per square centimeter of positive electrode surface area and per micrometer of positive electrode thickness (μAh/cm²/μm), for a discharge current substantially equal to 10 microamperes per square centimeter of positive electrode surface area (μA/cm²), and after the first 25 charge and discharge cycles of the battery have been conducted, each realized by varying the output voltage of the battery over a 2.3 V (volt) interval.

The positive electrode of a such a battery can be realized by a process as described above. Given that this process causes no significant heating of the electrode, the battery can be placed directly on a substrate which comprises a chip of an integrated circuit or a portion of a polymer material. “Battery placed directly on a substrate” is understood to mean a battery which is directly adjoining the substrate without being supported by an intermediate element intended to be assembled with the substrate after the realization of the positive electrode.

In different embodiments of a battery, one or more of the following performances can be obtained, individually or in combination: (a) after the above first 25 cycles, the discharge capacity of the battery is greater than 35 μAh/cm²/μm with reference to the positive electrode, for a discharge current which is substantially equal to 50 μA/cm², (b) the discharge capacity presents a variation which is less than 10 μAh/cm²/μm with reference to the positive electrode, during 25 later cycles each realized after the first 25 cycles by varying the output voltage of the battery over a 2.3 V interval, and (c) the difference between a charge capacity for a charge current substantially equal to 10 μA/cm², and a discharge capacity for a discharge current which is substantially equal to 10 μA/cm², is less than 5 μAh/cm²/μm with reference to the positive electrode, or even less than 3 μAh/cm²/μm, after the first 25 cycles.

### BRIEF DESCRIPTION OF THE DRAWINGS

Other features and advantages of the invention will become clear in the description which follows of several non-limiting examples, with references to the attached drawings wherein:

FIG. 1 is a cross-sectional diagram of a battery;

FIG. 2 is a diagram of a cathode sputtering deposition device used to implement a process;

FIG. 3 is an overview diagram of the steps of a process for realizing a positive electrode;

FIGS. 4 and 5 are two electrical characterizations of a battery; and

FIG. 6 is an electrical characterization of another battery.

### DETAILED DESCRIPTION OF THE DRAWINGS

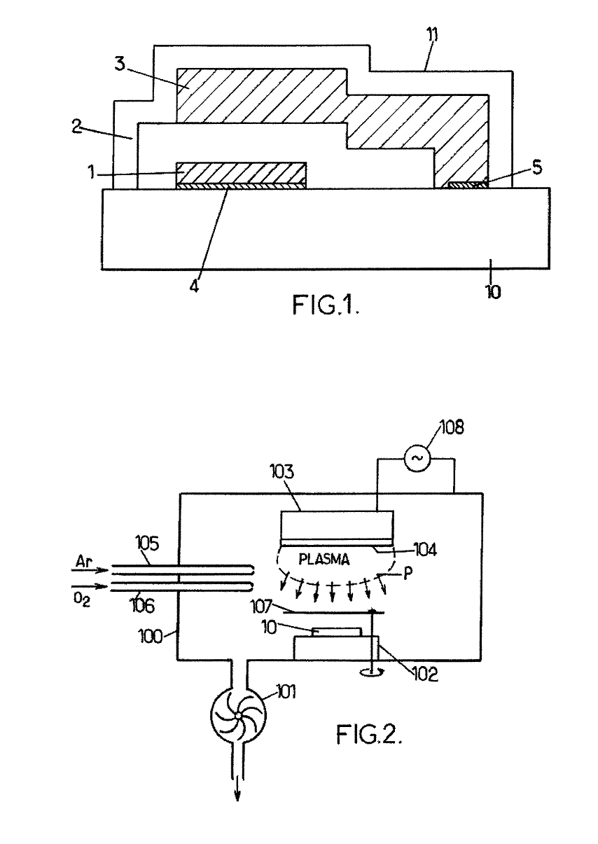

FIG. 1 illustrates a thin film battery which is realized on an integrated circuit. It is understood that the dimensions of the battery elements which are represented do not correspond to the true sizes or size ratios. The label 10 indicates a chip of an integrated circuit, which comprises, in the usual manner, a silicon substrate on which transistors are formed on its surface, several interconnection layers superimposed onto the substrate, and one or more encapsulation layers. These various elements of the chip are not individually represented, and the label 10 indicates the chip of the integrated circuit in general.

One side of the chip, which can be opposite the substrate, supports the following stack of battery layers: a positive electrode 1, an electrolyte 2, and a negative electrode 3. The battery is a lithium-ion battery. The positive electrode 1, or cathode, is of vanadium oxide of the stoichiometric formula V₂O₅ and is realized in a manner which will be described below in detail. It has, as an example, a thickness which can be substantially equal to 1 μm, and a surface area which can be substantially equal to 2 cm². The electrolyte 2 comprises a portion of lithium and phosphorus oxynitride (LiPON), 1.4 μm thick for example, and the negative electrode 3, or anode, can be a portion of a metallic lithium layer, 3.5 μm thick for example. The battery additionally comprises two electrical terminals 4 and 5, which are in contact with the electrodes 1 and 3 respectively. The terminals 4 and 5 are preferably composed of metal layer portions, such as portions of copper (Cu), titanium nitride (TiN), or tungsten (W).

The stack of battery layers is protected by an encapsulation portion 11, which may comprise, for example, a layer of polyparaxylylene about 5 μm thick, covered by a layer of a metal such as titanium or copper which is about 0.3 μm thick. Such an encapsulation protects the stack of battery layers against possible alterations caused by the air and/or exterior humidity.

The operation of such a lithium-ion battery is assumed to be known and is not given here. In an known manner, such a battery has a nominal output voltage in a vacuum which is substantially equal to 3.8 V. The only clarification is that the thickness and the characteristics of the negative electrode 3 are such that the performance of the battery, particularly its capacity, are determined by the positive electrode 1.

As shown in FIG. 2, a cathode sputtering deposition device comprises an enclosure 100 which is connected to a pumping system 101. The pumping system 101 is chosen so as to maintain a residual pressure, which can be less than 10⁻⁴ Pa (Pascal), inside the enclosure 100 when no gas is deliberately introduced into the enclosure.

The following elements are placed inside the enclosure 100: a support 102, to which the chip of the integrated circuit is fixed; an electrode 103 to power the plasma, placed facing the chip 10; a substantially pure vanadium target 104, in the form of a plate which is fixed to the electrode 103, such that one side of the plate is facing the side of the chip 10 on which the positive electrode 1 is to be formed; two gas injection lines 105 and 106, for injecting argon (Ar) and oxygen (O₂) respectively, equipped with flow meters adapted to control the rates at which these gases are introduced into the enclosure 100; and a mask 107, which moves between a first position which isolates the chip 10 relative to the target 104, and a second position which exposes the chip 10.

In the first position, the mask 107 is interposed between the target 104 and the chip 10, such that a continuous straight line cannot connect the chip to the target. In the second position, the chip 10 is exposed to particles coming directly from the target 104.

In a known manner, the target 104 is in electrical and thermal contact with the electrode 103. This electrode may contain a cooling system and magnetic field sources, which are not represented.

In addition, a source of alternating current 108, which can have a frequency of 13.6 MHz (megaHertz), is connected between the electrode 103 and a reference electrode, which can be formed by the enclosure itself when the enclosure is of metal.

When an appropriate gas is introduced into the enclosure 100, particularly a gas which contains argon, the electrical current source 108 generates a plasma which is particularly intense in proximity to the exposed surface of the target 104, because of the presence of magnetic field sources in the electrode 103. The positive ions of the plasma bombard the surface of the target 104 and sputtering occurs in the form of free vanadium aggregates or atoms. These, labeled P in FIG. 2, are deposited onto the chip 10 when the mask 107 is in the position that exposes the chip. The material which is thus formed on the chip 10 is simultaneously oxidized by oxygen atoms and ions present in the plasma, such that this material is the oxide of vanadium. The amount of oxygen which is introduced into the enclosure 100 during the deposition is sufficient for the oxide to have the stoichiometry V₂O₅.

It is assumed that the chip 10 which is installed onto the support 102 is already equipped with terminals 4 and 5, as well as an appropriate mask (not represented) to limit transversely the positive electrode 1 on the chip 10.

The realization of the positive electrode 1 on the chip 10, by cathode sputtering in the device which has just been described, is broken down into several sequences which are identical and executed in succession. The number of sequences is greater than or equal to three and each sequence comprises, in the order given: (A) a step of cooling the electrode 1 being realized on the chip 10, (B) a step of sputtering the target 104 in the absence of oxygen, with the mask 107 in the position which isolates the chip 10, (C) a step of sputtering the target 104 in the presence of oxygen, with the mask 107 in the position which isolates the chip 10, and (D) a step of depositing the vanadium oxide material onto the chip 10.

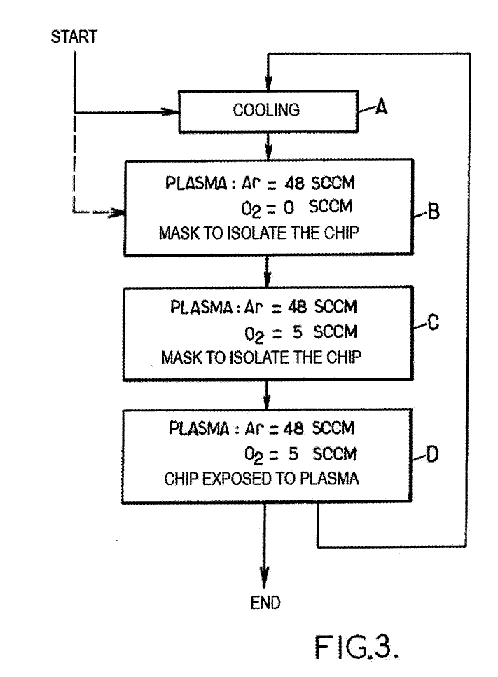

FIG. 3 indicates the parameters which are applied in the sputtering device during each step in the sequence.

In the first sequence to be executed, step A is optional.

When step D of a sequence is completed, a new sequence can be begun, or else the realization of the positive electrode 1 is ended when it is of the desired thickness.

The step A of cooling the electrode portion 1 which is already formed, and the chip 10, has a duration which is sufficient for the temperature of the electrode 1 to become less than 50° C. In fact, during the deposition step D in the previous sequence, the chip 10 received an amount of energy from the plasma and the atoms P projected from the target. This quantity of energy caused the chip 10 to heat. The duration of step A can be fixed based on a calibration experiment, or be determined by measuring the temperature of the electrode 1 being formed, for example using a thermocouple coupled to the chip 10 or a pyrometer which points in its direction. During step A, no plasma is formed in the enclosure 100, or any plasma which may be present is isolated from the chip 10 by the mask 107 in order to avoid slowing the cooling process.

The step B consists of sputtering the target 104 in the presence of a pure argon plasma. For example, when the active surface of the target 104 is approximately equal to 176 cm², the electrical power to the plasma can be equal to 800 W (Watt), and the flow rate for introducing the argon equal to 48 sccm (standard cubic centimeters per minute). The flow rate for introducing the oxygen is zero during this step B. The pressure within the enclosure 100, which can be adjusted by the pumping rate of the system 101, can be substantially equal to 0.5 Pa. It is then equal to the argon partial pressure.

Step C comprises sputtering the target 104 in the presence of oxygen. The flow rates for introducing argon and oxygen can be adjusted so that the argon partial pressure is still substantially equal to 0.5 Pascal, and the oxygen partial pressure is now substantially equal to 0.05 Pascal. To this end, the flow rates for introducing argon and oxygen into the enclosure 100 can be set at 48 sccm and 5 sccm respectively. The electrical power to the plasma can still be equal to 800 W. The pressure within the enclosure 100 is then substantially equal to 0.55 Pa.

During the steps B and C, the mask 107 isolates the chip 10 from the target 103, such that no new deposition is then formed on the chip 10.

The steps B and C can each have a duration which is substantially equal to 10 min (minutes).

Step D for each sequence constitutes the deposition of a part of the thickness of the positive electrode 1. The parameters for controlling this step can be the same as those for step C, but the mask 107 is now in the position which exposes the chip. For example, the electrical discharge of power to the plasma can be adjusted to obtain a deposition rate for the vanadium oxide which is substantially equal to 7.5 nm/min (nanometers per minute). The duration of step D can be determined by a maximum value for the temperature of the positive electrode 1 currently being formed, or be set to a fixed reference value. In the embodiment of the invention which is reported here, each step D has a minimum duration of 10 min. The inventors have in fact observed that this duration is particularly suitable for obtaining an amorphous and homogenous positive electrode.

Under the conditions which have just been described, each iteration of the complete sequence produces a portion of positive electrode 1 which has a thickness of 75 nm (nanometers). Positive electrodes 1 which have thicknesses of 0.23 μm (micrometers) and 0.90 μm have been produced by executing the sequence of steps A-D three and twelve times respectively. In general, the number of iterations of the sequence of steps A-D is determined by the thickness desired for the positive electrode 1.

The fabrication of the battery is then continued, in a manner which is known to a person skilled in the art, to obtain the configuration which is represented in FIG. 1.

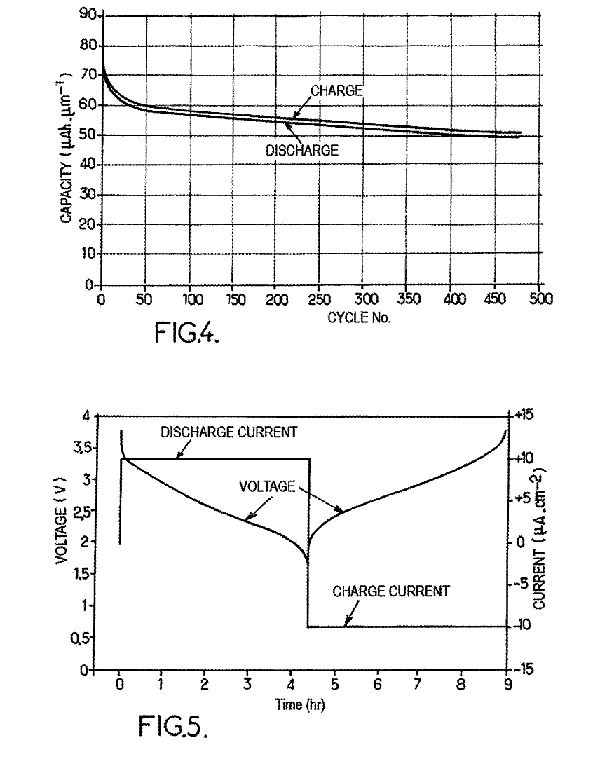

FIGS. 4 and 5 relate to a battery whose positive electrode is formed by a layer of vanadium oxide (V₂O₅) 1 μm thick and with a surface area of 2 cm², realized in six sequences, with a duration for step D of 20 min (minutes) for each sequence.

FIG. 4 is a diagram of the variation in the capacity of a battery obtained in this manner. The vertical axis indicates the value of the battery capacity, divided by the thickness of the positive electrode 1, for a positive electrode surface area of 2 cm². This capacity value is determined by imposing a charge-discharge cycle on the battery, with fixed values for the charge current then the discharge current. For the measurements indicated in this diagram, the charge and discharge currents imposed on each cycle are equal to 10 microamperes per square centimeter of positive electrode (μA/cm²), absolute value, and are maintained such that the voltage at the battery terminals varies between 2.15 and 3.8 V, meaning within an interval of 1.65 V. The horizontal axis indicates the number of the cycle within a series of cycles executed in succession.

FIG. 4 shows a constant gap between the charge and discharge capacities of the battery, which is substantially equal to 2.5 μAh.μm⁻¹. This gap is a measure of the amount of electrical charge introduced into the battery during the charge, but not supplied during the subsequent discharge. It therefore characterizes the irreversibility of the battery. This is probably due to an amount of lithium trapped in the positive electrode during the discharge.

The discharge capacity exceeds 50 μAh.82 m⁻¹ up to the four hundred fiftieth cycle, and presents a decrease of less than 10 μAh.μm⁻¹ over 400 cycles realized after the fiftieth cycle.

FIG. 5 shows the variations in voltage output from the same battery during a cycle realized under the conditions described above, for charge and discharge currents equal to 10 μA/cm⁻² (absolute value). The horizontal axis shows the time in hours. The cycle which is represented corresponds to a battery discharge period followed by a charge period. The jump in voltage which appears between the discharge periods and the charge periods is caused by a capacitive polarization of the battery. The absence of a leveling off in the battery discharge curve near output voltages of 2.2 V, 3.1 V and 3.33 V shows that the vanadium oxide material of the positive electrode 1 is amorphous, given that the variation in the amount of lithium atoms contained in this material does not cause any change in phase.

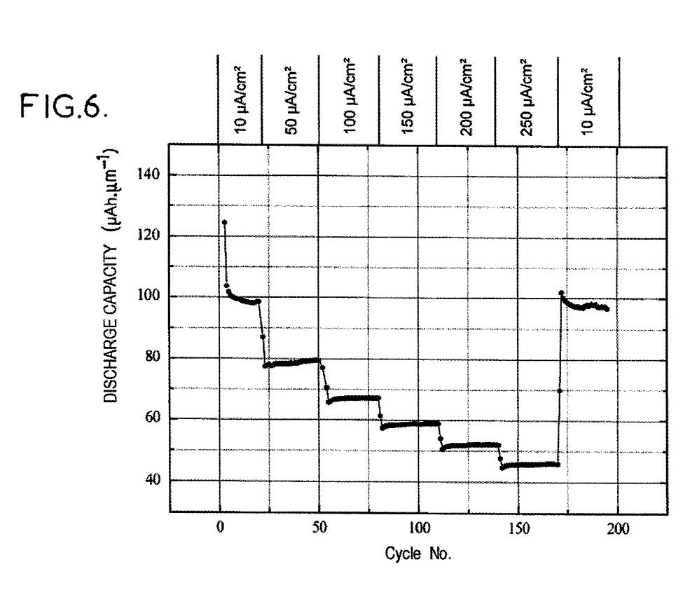

Lastly, FIG. 6 shows variations in the discharge capacity of another battery which incorporates a positive electrode 1 realized according to the invention. In this battery, the positive electrode 1 has been realized in four sequences, with deposition steps D lasting 30 min each. It has a thickness of 1 μm and a surface area of 2 cm². The different segments which appear in this diagram correspond to the various values imposed on the discharge current. These values are indicated above the diagram, and range from 10 to 250 μA/cm². All the charge-discharge cycles successively realized correspond to a battery output voltage which varies between 1.5 and 3.8 V. This diagram shows that, after the twenty-fifth cycle, the discharge capacity of the battery is reduced by an amount which is less than 10 μA.h/cm²/μm⁻¹ when the charge and discharge currents are increased from 10 to 50 μA/cm⁻². It also shows that when the discharge current was brought back to the initial value of 10 μA/cm², after which cycles were realized at variable discharge current values, the discharge capacity measured initially is still obtained. Thus the battery retains a constant performance during repeated uses. In addition, the discharge capacity remains significant for high current loads: approximately 45 μAh/μm for a discharge current of 250 μA/cm².

It is understood that the numeric values which are cited in the above description, and which concern the deposition conditions of the positive electrode, can vary while retaining at least some of the advantages of the invention. In particular, these values can be adapted as a function of the cathode sputtering device used.

Although preferred embodiments of the method and apparatus have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A process for realizing an electrode based on vanadium oxide, comprising:
performing at least three deposition steps (D), each deposition step accomplished by cathode sputtering of a vanadium-based metal target by means of a plasma containing argon and oxygen, and powered by a discharge of alternating current; and
wherein two successive deposition steps (D) are separated by:
(A) cooling of the electrode being realized to a temperature of less than 50° C.;
(B) first intermediate sputtering of the target without introducing oxygen into the plasma, for a first duration of more than 2 minutes; and
(C) second intermediate sputtering of the target in the presence of oxygen, for a second duration of more than 2 minutes;
wherein steps (B) and (C) are realized while the electrode is isolated from atoms originating from the target.

2. The process according to claim 1, wherein the respective first and second durations of steps (B) and (C) are between 2 minutes and 30 minutes, and preferably greater than 5 minutes.

3. The process according to claim 2, wherein the respective first and second durations of steps (B) and (C) are substantially equal to 10 minutes.

4. The process according to claim 1, wherein an argon partial pressure is between 0.1 Pascal and 2 Pascal during steps (B) and (C), and the oxygen partial pressure is between 0.01 Pascal and 0.2 Pascal during step (C).

5. The process according to claim 4, wherein the argon partial pressure is substantially equal to 0.5 Pascal during steps (B) and (C), and the oxygen partial pressure is substantially equal to 0.05 Pascal during step (C).

6. The process according to claim 1, wherein identical quantities of argon and oxygen are introduced into the plasma during the intermediate step (C) and during the subsequent deposition step (D).

7. The process according to claim 1, wherein each deposition step (D) is stopped before the temperature of the electrode being realized reaches 150° C.

8. The process according to claim 1, wherein each deposition step (D) has a duration of less than 30 minutes.

9. The process according to claim 8, wherein each deposition step (D) has a duration of between 10 and 20 minutes.

10. The process according to claim 1, wherein electrical discharge is adjusted during each deposition step (D) so as to obtain a deposition rate for the vanadium oxide which is between 1 and 20 nanometers per minute.

11. The process according to claim 10, wherein the electrical discharge is adjusted during each deposition step (D) so as to obtain a deposition rate for the vanadium oxide which is substantially equal to 7.5 nanometers per minute.

12. The process according to claim 1, wherein the electrode based on vanadium oxide is realized on a substrate comprising a chip of an integrated circuit, during the cathode sputtering deposition steps (D).

13. The process according to claim 1, wherein the electrode based on vanadium oxide is realized on a substrate comprising a portion of a polymer material, during the cathode sputtering deposition steps (D).

14. A lithium-ion battery comprising:
a positive electrode formed of a thin film based on amorphous vanadium oxide;
a negative electrode; and
an electrolyte placed between said positive and negative electrodes;
wherein said battery has a discharge capacity greater than 45 microampere.hours per square centimeter of positive electrode surface area and per micrometer of positive electrode thickness, for a discharge current substantially equal to 10 microamperes per square centimeter of positive electrode surface area and after 25 first charge and discharge cycles of the battery, with each cycle realized by varying an output voltage of said battery over a 2.3 Volt interval.

15. The battery according to claim 14, additionally having, after said 25 first cycles, a discharge capacity greater than 35 μAh/cm²/μm with reference to the positive electrode, for a discharge current substantially equal to 50 μA/cm².

16. The battery according to claim 14, having a variation in the discharge capacity of less than 10 μAh/cm²/μm with reference to the positive electrode, during 25 later cycles each realized after said 25 first cycles by varying the output voltage of the battery over a 2.3 Volt interval.

17. The battery according to claim 14, additionally having a difference between a charge capacity for a charge current substantially equal to 10 μA/cm², and the discharge capacity for the discharge current substantially equal to 10 μA/cm², of less than 5 μAh/cm²/μm with reference to the positive electrode, after said 25 first cycles each realized by varying the output voltage of the battery over a 2.3 Volt interval.

18. The battery according to claim 17, wherein the difference between the charge capacity for the charge current substantially equal to 10 μA/cm², and the discharge capacity for the discharge current substantially equal to 10 μA/cm², is less than 3 μAh/cm²/μm with reference to the positive electrode after said 25 first cycles.

19. The battery according to claim 14, placed directly on a substrate comprising a chip of an integrated electronic circuit.

20. The battery according to claim 14, placed directly on a substrate comprising a portion of a polymer material.

21. A process for realizing a positive electrode of a lithium-ion battery, comprising:
deposition by cathode sputtering in several steps;
wherein two successive deposition steps are separated by:
cooling of the electrode;
a first intermediate sputtering without introducing oxygen; and
a second intermediate sputtering while introducing oxygen.

22. The process according to claim 21, wherein deposition by cathode sputtering comprises forming the electrode on a substrate comprising a chip of an integrated circuit.

23. The process according to claim 21, wherein deposition by cathode sputtering comprises forming the electrode on a substrate comprising a portion of a polymer material.
